(19) United States
(12) Patent Application Publication
(10) Pub. No.: US 2026/0149019 A1
(43) Pub. Date: May 28, 2026

(54) METHOD OF STARTING OPERATION OF FUEL CELL SYSTEM, AND FUEL CELL SYSTEM

(71) Applicant: HONDA MOTOR CO., LTD., Tokyo (JP)

(72) Inventor: Yusuke SHINDO, Wako-shi (JP)

(21) Appl. No.: 19/392,800

(22) Filed: Nov. 18, 2025

(30) Foreign Application Priority Data
Nov. 22, 2024 (JP) 2024-204008

(51) Int. Cl. H01M 8/04858; H01M 8/04111; H01M 8/04225; H01M 16/00

(52) U.S. Cl. CPC H01M 8/04925; H01M 8/04111; H01M 8/04225; H01M 16/003; H01M 2250/402

(57) ABSTRACT

In a method of starting operation of a fuel cell system, the fuel cell system includes a fuel cell and a boost converter including a capacitor in an output stage. The method includes a step of supplying a hydrogen gas to an anode in a state where the operation of a fuel cell is not started, generating an electromotive force based on a difference in hydrogen gas activity between the anode and a cathode, and configuring the fuel cell as a hydrogen concentration cell, and a step of precharging the capacitor with electrical power supplied from the fuel cell configured as the hydrogen concentration cell.

### CROSS REFERENCE TO RELATED APPLICATIONS

This application is based upon and claims the benefit of priority from Japanese Patent Application No. 2024-204008 filed on Nov. 22, 2024, the contents of which are incorporated herein by reference.

### BACKGROUND

### Technical Field

The present disclosure relates to a method of starting operation of a fuel cell system

that generates electrical power through an electrochemical reaction between a fuel gas and an oxygen-containing gas, and a fuel cell system.

### Background Art

In recent years, research and development have been conducted on fuel cells that contribute to energy efficiency in order to ensure that more people have access to affordable, reliable, sustainable and modern energy.

JP 7533678 B1 discloses an electrical power system for an electric vehicle that performs precharge using a boost converter.

### SUMMARY OF THE INVENTION

There is a demand for a more satisfactory method of starting operation of a fuel cell system, and a more satisfactory fuel cell system. In order to promote the spread of the fuel cell system, it is required to minimize the number of components and to reduce the cost by integrating functional components. In particular, a precharge contactor used for coupling the fuel cell system to another system in the vehicle is a component used only at the time of starting operation of the vehicle system and is a device that is not used in most of the time of use of the vehicle system, and thus simplification is strongly required.

The present invention has the object of solving the aforementioned problem.

A first aspect of the present disclosure is characterized by a method of starting operation of the fuel cell system, the fuel cell system including a fuel cell configured to generate electrical power through an electrochemical reaction between a hydrogen gas supplied from a fuel gas supply device to an anode and an oxygen-containing gas supplied from an oxygen-containing gas supply device to a cathode, and a boost converter including a capacitor in an output stage and configured to increase an output voltage of the fuel cell, the method including the step of, in a state where the operation of the fuel cell is not started, supplying the hydrogen gas to the anode, and generating an electromotive force based on an activity difference of the hydrogen gas between the anode and the cathode to configure the fuel cell as a hydrogen concentration cell, and the step of precharging the capacitor with an electrical power supplied from the fuel cell configured as the hydrogen concentration cell.

A second aspect of the present disclosure is characterized by a fuel cell system including a fuel cell configured to generate electrical power through an electrochemical reaction between a hydrogen gas supplied from a fuel gas supply device to an anode and an oxygen-containing gas supplied from an oxygen-containing gas supply device to a cathode, a boost converter including a capacitor in an output stage and configured to increase an output voltage of the fuel cell, and a control device configured to control the fuel gas supply device, the oxygen-containing gas supply device, the fuel cell, and the boost converter, wherein the control device is configured to, in a state where operation of the fuel cell is not started, drive the fuel gas supply device to supply the hydrogen gas to the anode, generate an electromotive force based on an activity difference of the hydrogen gas between the anode and the cathode to configure the fuel cell as a hydrogen concentration cell, and precharge the capacitor with an electrical power supplied from the fuel cell configured as the hydrogen concentration cell.

According to the present disclosure, a more favorable method of starting operation of a fuel cell system and a more favorable fuel cell system can be provided.

The above and other objects, features, and advantages of the present invention will become more apparent from the following description when taken in conjunction with the accompanying drawings, in which a preferred embodiment of the present invention is shown by way of illustrative example.

### DESCRIPTION OF THE DRAWINGS

FIG. 1 is a schematic configuration diagram of a fuel cell vehicle incorporating a fuel cell system according to an embodiment;

FIG. 2 is a schematic configuration diagram of a fuel cell voltage control unit (FCVCU);

FIG. 3 is a flowchart for explaining a starting process of the fuel cell system;

FIG. 4 is a flowchart for explaining a precharge process by a hydrogen concentration cell; and

FIG. 5 is a schematic configuration diagram of a fuel cell voltage control unit (FCVCU) as a comparative example.

### DETAILED DESCRIPTION

Conventionally, a fuel cell system has been proposed that includes a fuel cell, a secondary battery, and a boost converter that has a smoothing capacitor at an output stage and increases an output voltage of the fuel cell to apply the boosted voltage to a load and the secondary battery.

The conventional fuel cell system includes a main contactor and a precharge circuit provided in parallel with the main contactor between the smoothing capacitor and the secondary battery. The precharge circuit includes a precharge contactor and a current limiting resistor arranged in series with the contactor. In this fuel cell system, before the operation of the fuel cell is started, the precharge contactor is first closed, and the smoothing capacitor is charged with the output electrical power of the secondary battery via the current limiting resistor. After the voltage between the terminals of the smoothing capacitor rises and there is no longer a risk of welding due to overcurrent, the main contactor is closed, and the operation of the fuel cell is started. Charging the smoothing capacitor via the precharge circuit before closing the main contactor is referred to as precharging.

The precharge circuit is used only for precharging the smoothing capacitor. After the operation of the fuel cell is started, the precharge circuit is not used until the operation of the fuel cell is started again. The operating time of the precharge circuit is very short compared to the operating time of the entire fuel cell system.

Therefore, if the smoothing capacitor can be precharged without using the precharge circuit, the precharge circuit (the precharge contactor and the current limiting resistor) can be removed, and the number of components of the fuel cell system can be minimized and the cost can be reduced.

In the present disclosure, the capacitor can be precharged without using a precharge circuit. Hereinafter, a method of starting operation of a fuel cell system and a fuel cell system according to the present disclosure will be described.

### Embodiment

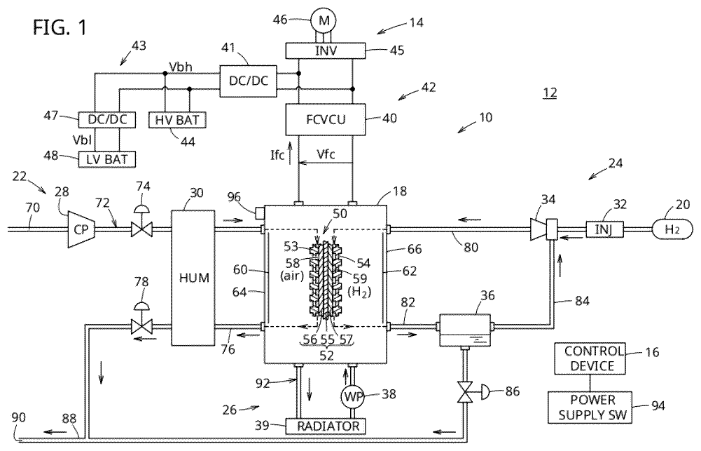

FIG. 1 is a schematic configuration diagram of a fuel cell vehicle 12 in which a fuel cell system 10 according to an embodiment is incorporated.

The fuel cell system 10 can be incorporated into other mobile bodies such as ships, flying objects including aircrafts, and robots other than the fuel cell vehicle 12.

### Configuration of Fuel Cell System

The fuel cell vehicle 12 includes the fuel cell system 10, an output device 14 electrically connected to the fuel cell system 10, and a control device 16 that controls the entire fuel cell vehicle 12 (including the fuel cell system 10 and the output device 14). For example, the control device 16 may be divided into two or more control devices such as a control device for the fuel cell system 10 and a control device for the output device 14.

The fuel cell system 10 includes a fuel cell stack (also simply referred to as a fuel cell or an FC) 18, an oxygen-containing gas supply device 22, a fuel gas supply device 24, and a coolant supply device 26.

The oxygen-containing gas supply device 22 includes a compressor (CP) 28 that is an air compressor, and a humidifier (HUM) 30. The fuel gas supply device 24 includes a fuel tank (a hydrogen tank or a fuel gas tank) 20, an injector (INJ) 32, an ejector 34, and a gas-liquid separator 36. The injector 32 may be replaced by a pressure reducing valve. A coolant pump (WP) 38 and a radiator 39 are included in the coolant supply device 26.

The output device 14 includes a voltage conversion unit 42, an electrical power storage unit 43, and a motor (electric motor) 46. The voltage conversion unit 42 includes an inverter 45, a fuel cell voltage control unit (FCVCU) 40, and a DC/DC converter (SUDC) 41 that is a step-up/step-down converter. A high voltage electrical power storage device (high voltage battery, HV BAT) 44, a DC/DC converter (SDC) 47 that is a step-down converter, and a low voltage electrical power storage device (low voltage battery, LV BAT) 48 are included in the electrical power storage unit 43.

A load is connected to the voltage conversion unit 42 and the electrical power storage unit 43. The load includes the motor 46 as a main machine, a high voltage auxiliary device to which electrical power is supplied from the high voltage electrical power storage device 44, and a low voltage auxiliary device to which electrical power is supplied from the low voltage electrical power storage device 48. The high voltage auxiliary devices include, for example, the compressor 28, the coolant pump 38, and heaters (electric heaters) 60, 62 described later. The low voltage auxiliary devices include the control device 16, various sensors, various solenoid valves, the injector 32, and the like.

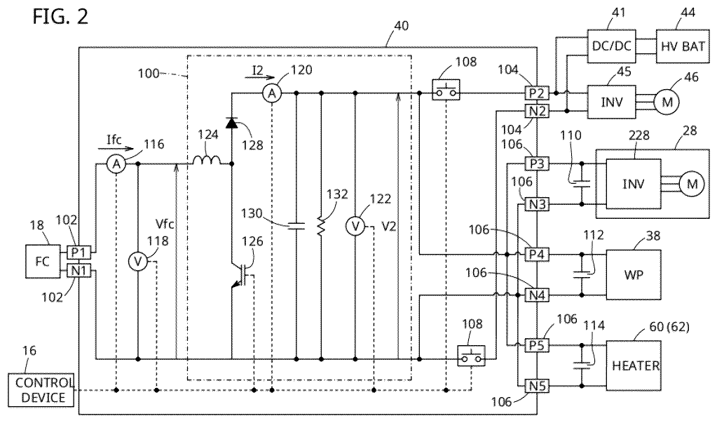

As shown in FIG. 2, the FCVCU 40 includes a DC/DC converter (SUC, a boost converter) 100, which is a boost converter or a step-up converter. The DC/DC converter 100 converts and increases an output voltage Vfc, which is a generated voltage of a DC voltage from the fuel cell stack 18, and applies a high voltage for driving to a DC terminal of the inverter 45, the DC/DC converter 41, and the above-described high voltage auxiliary devices. The FCVCU40 will be described in detail later.

Referring back to FIG. 1, the DC/DC converter 41 converts the high voltage for driving into a battery voltage Vbh of the electrical power storage device 44 by step-down conversion, and charges the high voltage electrical power storage device 44. The DC/DC converter 47 steps down the battery voltage Vbh to a low battery voltage Vbl, and charges the low voltage electrical power storage device 48.

A high voltage obtained by converting and increasing the battery voltage Vbh by the DC/DC converter 41 is applied to a DC terminal of the inverter 45. The DC terminal of the inverter 45 is applied with a high voltage obtained by stepping up the output voltage Vfc by a FCVCU40.

The inverter 45 converts the high voltage of the DC current into a three-phase alternating current, and thereby drives the motor 46. The inverter 45 converts a regenerative voltage of the motor 46 into a high DC voltage. Such a high DC voltage is converted into a low voltage by the DC/DC converter 41, and is applied to the high voltage electrical power storage device 44, and thereby charges the high voltage electrical power storage device 44. The fuel cell vehicle 12 travels due to a driving force generated by the motor 46.

The fuel cell stack 18 includes a plurality of power generation cells 50. The plurality of power generation cells 50 are stacked between an end plate 64 and an end plate 66. Each of the power generation cells 50 includes a membrane electrode assembly 52 and separators 53, 54 sandwiching the membrane electrode assembly 52.

The membrane electrode assembly 52 is equipped, for example, with a solid polymer electrolyte membrane 55 that is a thin film of perfluorosulfonic acid containing water, and a cathode 56 and an anode 57 that sandwich the solid polymer electrolyte membrane 55 therebetween.

The cathode 56 and the anode 57 each include a gas diffusion layer (not shown) made of carbon paper or the like. An electrode catalyst layer (not shown) is formed by depositing porous carbon particles uniformly on the surface of the gas diffusion layer, and platinum alloy is supported on the surfaces of the porous carbon particles. The electrode catalyst layer is formed on both sides of the solid polymer electrolyte membrane 55.

On a surface of the one separator 53 facing the membrane electrode assembly 52, a cathode flow field (oxygen-containing gas flow field) 58 along the cathode 56 is formed. On a surface of the other separator 54 facing the membrane electrode assembly 52, an anode flow field (fuel gas flow field) 59 along the anode 57 is formed.

The fuel cell stack 18 is further provided with a voltage monitoring device (CVM: Cell Voltage Monitor) 96 that detects a voltage for each of the power generation cells 50 or for each of the several power generation cells 50.

Plate-shaped heaters 60 and 62 are provided inside the end plate 64 and inside the end plate 66, respectively. The heaters 60 and 62 heat the inside of the fuel cell stack 18, as necessary.

The compressor 28 draws in outside air (atmosphere, air) from an outside air intake port 70, pressurizes the outside air, and supplies the pressurized outside air to the fuel cell stack 18 through the humidifier 30.

An inlet side sealing valve 74 is provided in an oxygen-containing gas supply flow path 72 that causes the outside air intake port 70 and the inlet of the cathode flow field 58 to communicate with each other. The flow paths such as the oxygen-containing gas supply flow path 72 drawn by double lines are formed by pipes (the same applies hereinafter). The degree to which the inlet side sealing valve 74 is opened can be variably controlled by the control device 16, and the inlet side sealing valve 74 opens and closes the oxygen-containing gas supply flow path 72.

An outlet side sealing valve 78 is provided in an oxygen-containing off-gas discharge flow path 76 communicating with an outlet of the cathode flow field 58. The outlet side sealing valve 78 also functions as a back pressure valve. The degree to which the outlet side sealing valve 78 is opened can be variably controlled by the control device 16, and the outlet side sealing valve 78 opens and closes the oxygen-containing off-gas discharge flow path 76.

The fuel tank 20 is a container that stores high-purity hydrogen compressed at a high pressure. The fuel gas (hydrogen) discharged from the fuel tank 20 is supplied to the inlet of the anode flow field 59 via the injector 32 and the ejector 34 provided in a fuel gas supply flow path 80. The outlet of the anode flow field 59 is connected to the gas-liquid separator 36 through a fuel off-gas discharge flow path 82, and the fuel off-gas is supplied to the gas-liquid separator 36.

The gas-liquid separator 36 separates the fuel off-gas into a gas component and a liquid component (liquid water). The gas component of the fuel off-gas (fuel off-gas) is supplied to the suction port of the ejector 34 through the circulation flow path 84. The liquid component (liquid water) of a fuel off-gas is mixed with the exhaust gas discharged from the oxygen-containing off-gas discharge flow path 76, and is discharged to the outside (atmosphere) of the fuel cell vehicle 12 through a drain valve 86, the discharge flow path 88, and an exhaust gas exhaust port 90.

The coolant supply device 26 includes a coolant flow path 92 through which a coolant (a cooling medium) as a heat medium flows, the coolant pump 38, and the radiator 39. The coolant pump 38 circulates the coolant in the coolant flow path 92.

The above-described components of the fuel cell system 10 are collectively controlled by the control device 16. The control device 16 is configured by an electronic control unit (ECU). The ECU is configured by a computer including one or more processors (CPUs), a memory, an input/output interface, and an electronic circuit. The at least one processor (CPU) executes a non-illustrated program (computer-executable instructions) that is stored in a memory.

The processor of the control device 16 performs operation control of the fuel cell vehicle 12 and the fuel cell system 10 by executing calculation in accordance with the program.

A power supply switch (power supply SW) 94 of the fuel cell vehicle 12 is connected to the control device 16. The power supply switch 94 is operated by a user to start, continue (ON), or end (OFF) the power generation operation of the fuel cell stack 18 of the fuel cell system 10.

### Configuration of FCVCU

FIG. 2 is a schematic configuration diagram of the FCVCU40.

The FCVCU40 is a voltage converter including a DC/DC converter (SUC) 100 of the chopper type. The FCVCU40 includes an input unit 102 connected to the output terminal of the fuel cell stack 18, an input/output unit 104 connected to the inverter 45, and an output unit 106 connected to a high voltage auxiliary device such as the compressor 28. The input/output unit 104 is connected to the inverter 45, and is also connected to the high voltage electrical power storage device 44 via the DC/DC converter 41 and to the low voltage electrical power storage device 48 via the DC/DC converter 47. In FIG. 2, the DC/DC converter 47 and the electrical power storage device 48 are not shown.

The input unit 102 includes a positive terminal P1 and a negative terminal N1. The input/output unit 104 includes a positive terminal P2 and a negative terminal N2. The output unit 106 includes a positive terminal P3 and a negative terminal N3 connected to the compressor 28, a positive terminal P4 and a negative terminal N4 connected to the coolant pump 38, and a positive terminal P5 and a negative terminal N5 connected to the heaters 60 and 62.

The DC/DC converter 100 and a main contactor 108 are provided between the input unit 102 and the input/output unit 104. The main contactor 108 functions as a switch that can be switched between ON and OFF (closed and open) by the control device 16.

The output unit 106 is connected to the secondary side of the DC/DC converter 100 and the primary side of the main contactor 108. When the main contactor 108 is turned ON, the battery voltage Vbh is applied to a compressor inverter (INV) 228 via the output unit 106. Similarly, when the main contactor 108 is turned ON, the battery voltage Vbh is applied to the coolant pump 38 and the heaters 60 and 62 via the output unit 106.

The compressor 28, the coolant pump 38, and the heaters 60 and 62 are provided with smoothing capacitors 110, 112, 114, respectively. Due to protection of these smoothing capacitors 110, 112, 114, it is necessary to prevent an overcurrent (inrush current) flowing thereto at the time the main contactor 108 is turned ON.

A current sensor 116, a voltage sensor 118, a current sensor 120, and a voltage sensor 122 are provided in the FCVCU40. The current sensor 116 detects an output current Ifc of the fuel cell stack 18 and outputs the output current Ifc to the control device 16. Similarly, the voltage sensor 118 detects an output voltage Vfc from the fuel cell stack 18, and the current sensor 120 detects the secondary-side current I2 of the DC/DC converter 100. The voltage sensor 122 detects a secondary side voltage V2 of the DC/DC converter 100 (a voltage between terminals of a smoothing capacitor 130 described later). Both the detected current values and voltage values are output to the control device 16.

The DC/DC converter 100 may have various configurations, but as is known, the DC/DC converter 100 basically includes a reactor (inductor) 124, a switching element 126 such as a MOSFET or an IGBT, a diode 128, and the smoothing capacitor (capacitor) 130. The switching element 126 is subjected to ON/OFF switching control (duty control) by the control device 16 based on the required electrical power of the load.

Specifically, as shown in FIG. 2, the DC/DC converter 100 includes the reactor 124, the switching element 126, the diode 128 (a unidirectional current passing element, a reverse current blocking element), a smoothing capacitor 130, and a discharge resistor 132. The switching element 126 is subjected to duty control through the control device 16 that functions as a converter controller. Thus, the DC/DC converter 100 increases the output voltage Vfc of the fuel cell stack 18. Due to protection of the smoothing capacitor 130, it is necessary to prevent an overcurrent (inrush current) flowing thereto at the time the main contactor 108 is turned ON.

When Vfc>V2, the fuel cell stack 18 and the smoothing capacitor 130 are directly connected through the reactor 124 and the diode 128, and the output voltage Vfc from the fuel cell stack 18 is directly connected to the voltage V2 between the terminals of the smoothing capacitor 130 without switching (where V2=Vfc−Vd≈Vfc, Vd<<Vfc, Vd: Forward voltage drop of the diode 128). The diode 128 operates for increasing the voltage, or for coupling directly and preventing the reverse current. Therefore, the DC/DC converter 100 performs a reverse current prevention operation and a direct-coupling operation (during power running or the like) in addition to a voltage-increasing operation (during power running or the like).

### Operation

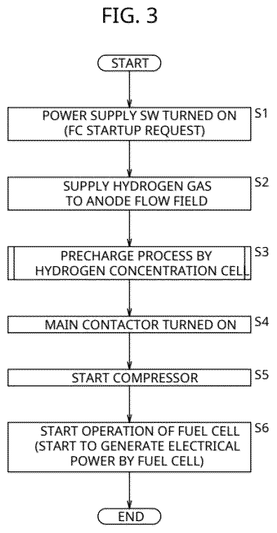

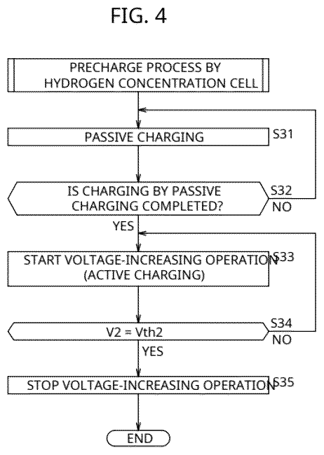

The fuel cell system 10 according to the present embodiment is configured basically as described above. Hereinafter, the method of starting operation of the fuel cell system 10 will be described with reference to the flowchart of FIGS. 3 and 4.

FIG. 3 is a flowchart for explaining a starting process of the fuel cell system 10. In the initial state, the power supply switch 94 of the fuel cell vehicle 12 is in the OFF state, and the fuel cell system 10 is in the stop state (operation stop state).

In the stop state, all the valves of the fuel cell system 10 are closed. The cathode flow field 58 of the fuel cell stack 18 is substantially filled with a high-concentration inert gas (nitrogen gas) by the stop time power generation process (so-called O₂ lean power generation process). In the cathode flow field 58, a small amount of water molecules may exist as water vapor in addition to the inert gas (nitrogen gas). The hydrogen gas at an appropriate concentration remains in the anode flow field 59 of the fuel cell stack 18.

In step S1, the power supply switch 94 receives an ON operation (FC startup request) by the user. Thus, the starting process of the fuel cell system 10 is initiated.

Next, in step S2, the control device 16 controls the injector 32 to supply a predetermined amount of hydrogen gas to the anode flow field 59. The injector 32 is driven by the control device 16 under a PWM control, for example, and thus can adjust the supply amount of the fuel gas. As is well known, driving under the PWM control is an electrical power control method in which a constant cycle of ON and OFF of a pulse train is created, and a time width (ON duty) thereof is caused to be changed.

When the hydrogen gas is supplied to the anode flow field 59, the hydrogen concentration on the anode 57 side rises. On the other hand, the cathode 56 side is substantially filled with a high-concentration inert gas (nitrogen gas). Therefore, the hydrogen concentration on the anode 57 side is higher than the hydrogen concentration on the cathode 56 side.

At this time, a hydrogen concentration cell is formed between the anode 57 side having a high hydrogen concentration and the cathode 56 side having a low hydrogen concentration. That is, an electromotive force based on the difference in activity of the hydrogen gas is generated. As the activity of the hydrogen gas, the concentration or partial pressure thereof can be used.

Therefore, at the anode 57 having a high hydrogen concentration, the hydrogen molecules (H₂) are ionized to generate protons (H⁺) and electrons (e⁻). The protons (H⁺) generated at the anode 57 pass through the solid polymer electrolyte membrane 55 and move toward the cathode 56 having a low hydrogen concentration. The electrons (e⁻) generated at the anode 57 move from the output terminal of the fuel cell stack 18 to the cathode 56 side through the external circuit (FCVCU 40).

At the cathode 56, protons (H⁺) that have permeated the solid polymer electrolyte membrane 55 and reached the cathode 56 receive electrons (e⁻) that have reached the cathode 56 via the external circuit, and hydrogen molecules (H₂) are generated again. These reactions continue until the hydrogen concentration on the anode 57 side and the hydrogen concentration on the cathode 56 side reach equilibrium.

The electromotive force of the hydrogen concentration cell can be generally obtained by the Nernst equation.

When a predetermined amount of hydrogen gas is supplied to the anode flow field 59 in step S2, the process proceeds to step S3. In step S3, the precharge process of the smoothing capacitor 130 by the hydrogen concentration cell is executed.

FIG. 4 is a flowchart for explaining a precharge process by a hydrogen concentration cell.

In the precharge process (precharge operation) by the hydrogen concentration cell, passive charging is first performed in step S31. The passive charging means that the switching element 126 of the FCVCU 40 is maintained in an OFF state (open state), and the fuel cell stack 18 and the smoothing capacitor 130 of the DC/DC converter 100 are directly connected through the diode 128. When the switching element 126 is turned OFF, the smoothing capacitor 130 is charged with the output voltage Vfc of the fuel cell stack 18 (the supply voltage of the hydrogen concentration cell).

When the switching element 126 is turned OFF (open state), the smoothing capacitors 110, 112, 114 provided in the compressor 28, the coolant pump 38, and the heaters 60, 62 are also directly connected to the fuel cell stack 18 through the diode 128. As a result, the smoothing capacitors 110, 112, 114 are also charged with the output voltage Vfc of the fuel cell stack 18 (the supply voltage of the hydrogen concentration cell).

In step S32, it is determined whether or not the charging by the passive charging is completed. The control device 16 may compare the voltage V2 between the terminals of the smoothing capacitor 130 with a predetermined voltage value Vth1 during the execution of the passive charging, for example, and determine that the charging by the passive charging is completed when the voltage V2 between the terminals of the smoothing capacitor 130 becomes the predetermined voltage value Vth1. The predetermined voltage value Vth1 is set to a voltage value slightly lower than the output voltage Vfc of the fuel cell stack 18 in consideration of the forward voltage drop Vd of the diode 128. When the voltage V2 between the terminals of the smoothing capacitor 130 is smaller than the predetermined voltage value Vth1, the passive charging is continued (step S32: NO).

In step S32, the control device 16 may determine whether the charging of the passive charging is completed, using the output current Ifc outputted from the fuel cell stack 18 instead of the voltage V2 between the terminals of the smoothing capacitor 130. That is, the control device 16 may determine that the charging by the passive charging is completed when the output current Ifc of the fuel cell stack 18 becomes less than a predetermined current value Ith during the execution of the passive charging. The predetermined current value Ith is set to a value with which it is possible to prevent the charging current flowing into the smoothing capacitor 130 from becoming an overcurrent in the next step (step S33), for example. As a result, even before the voltage V2 between the terminals of the smoothing capacitor 130 reaches the predetermined voltage value Vth1, the process can proceed to the next step (step S33) and active charging described later can be started. When the output current Ifc from the fuel cell stack 18 is equal to or higher than the predetermined current value Ith, the passive charging is continued (step S32: NO).

When the charging of the smoothing capacitor 130 by way of the passive charging is completed (step S32: YES), the process proceeds to step S33.

In step S33, the control device 16 starts the voltage-increasing operation of the DC/DC converter 100. The DC/DC converter 100 steps up the output voltage Vfc of the fuel cell stack 18 by the on/off switching control of the switching element 126. As a result, more charge is stored in the smoothing capacitor 130, and the voltage V2 between the terminals of the smoothing capacitor 130 rises. The charging accompanied by the voltage-increasing operation of the DC/DC converter 100 is hereinafter referred to as active charging.

In the active charging, the control device 16 may control the DC/DC converter 100 such that the output current Ifc of the fuel cell stack 18 becomes a predetermined current value (current control). The control device 16 may control the DC/DC converter 100 such that the output voltage Vfc of the fuel cell stack 18 becomes a predetermined voltage value (voltage control). The control device 16 may control the DC/DC converter 100 such that the power Pfc supplied from the fuel cell stack 18 is maximized (Maximum Power Point Tracking (MPPT) Control).

The active charging is continued until the voltage V2 between the terminals of the smoothing capacitor 130 reaches the target voltage (predetermined voltage value) Vth2 (step S34: NO). The target voltage Vth2 may be set to the battery voltage Vbh of the high voltage electrical power storage device 44 or a value related to the battery voltage Vbh. When the smoothing capacitor 130 is charged to the target voltage Vth2 (step S34: YES), the control device 16 stops the voltage-increasing operation of the DC/DC converter 100 in step S35, and ends the precharge process by the hydrogen concentration cell.

The hydrogen concentration cell has a characteristic that the concentration difference is reduced by the transport of hydrogen from the anode to the cathode by its own operation, and the electromotive force is reduced. Therefore, it is desirable that the precharge operation (steps S31 to S35) be completed in as short a time as possible so that the partial hydrogen pressure to which the cathode is exposed can be kept low.

Returning to the flowchart shown in FIG. 3, in step S4, the control device 16 turns ON the main contactor 108. At this time, sufficient electric charge is stored in the smoothing capacitor 130. The voltage difference |Vbh−V2| between the voltage V2 between the terminals of the smoothing capacitor 130 and the battery voltage Vbh becomes smaller than the predetermined value. Therefore, a large inrush current does not flow through the main contactor 108.

In step S5, the control device 16 starts the compressor 28. The inlet side sealing valve 74 and the outlet side sealing valve 78 are opened, and the oxygen-containing gas is supplied to the cathode flow field 58. This allows the hydrogen gas (H₂ gas) generated on the cathode 56 side to be scavenged and discharged from the exhaust gas exhaust port 90. The inlet side sealing valve 74 and the outlet side sealing valve 78 may be opened in advance before the compressor 28 is started.

In step S6, the control device 16 starts the operation of the fuel cell (fuel cell stack) 18. While continuing the supply of the oxygen-containing gas to the cathode 56, the hydrogen gas is supplied from the fuel tank 20 to the anode 57. Thus, the fuel cell (fuel cell stack) 18 starts to generate electrical power through the electrochemical reaction of the oxygen-containing gas and the hydrogen gas.

In the above-described step S35, the control device 16 may proceed to step S4 without stopping the voltage-increasing operation of the DC/DC converter 100. That is, the control device 16 may start the electrical power generation of the fuel cell stack 18 without stopping the voltage-increasing operation of the DC/DC converter 100, and may shift to the normal control (operation control) of the fuel cell stack 18.

### Comparative Example

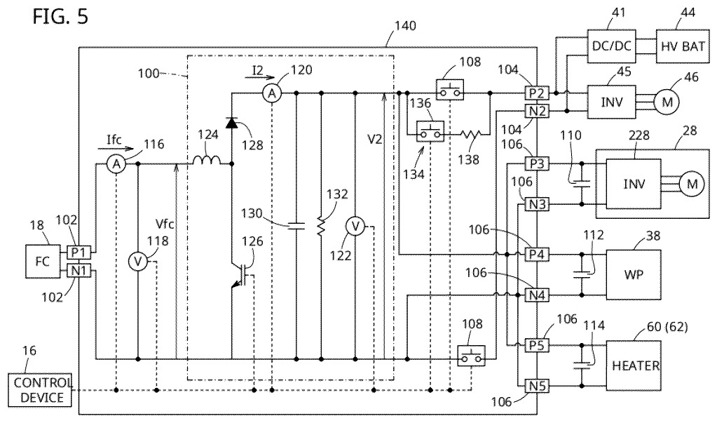

FIG. 5 is a schematic configuration diagram of an FCVCU 140 as a comparative example.

A precharge circuit 134 is provided in the FCVCU140 in the comparative example. In the comparative example, the components other than the precharge circuit 134 are common to the components of the FCVCU 40 shown in FIG. 2, and thus are denoted by the same reference characters as the components of the FCVCU 40.

The precharge circuit 134 includes a precharge contactor 136 and a current limiting resistor 138 arranged in series with the precharge contactor 136. In this comparative example, the smoothing capacitor 130 is precharged with the electrical power supplied from the high voltage electrical power storage device 44.

That is, when the operation of the fuel cell 18 is started, the precharge contactor 136 is first turned ON (closed) under the OFF state of the main contactor 108. The battery voltage Vbh of the electrical power storage device 44 is applied to the smoothing capacitor 130 via the current limiting resistor 138, and the smoothing capacitor 130 is precharged via the current limiting resistor 138 and the precharge contactor 136 with the power supplied from the electrical power storage device 44. After the voltage V2 between the terminals of the smoothing capacitor 130 rises and there is no longer a possibility of overcurrent, the main contactor 108 is turned ON (closed) and the operation of the fuel cell 18 is started.

As described above, the precharge circuit 134 in the comparative example is a component used only at the time of starting operation of the fuel cell system 10, and is a device that is not used in most of the actual use time of the fuel cell system 10, and therefore, simplification is required.

In contrast, the method of starting operation of the fuel cell system 10 according to the present embodiment includes the step S2 of supplying hydrogen gas to the anode 57 in a state where the operation of the fuel cell 18 is not started, generating an electromotive force based on the difference in hydrogen gas activity (difference in concentration, difference in partial pressures) between the anode 57 and the cathode 56, and configuring the fuel cell 18 as a hydrogen concentration cell, and the step S3 of precharging the smoothing capacitor 130 with the electrical power Pfc supplied from the fuel cell 18 configured as a hydrogen concentration cell.

The fuel cell system 10 according to the present embodiment includes the control device 16, and the control device 16 drives the fuel gas supply device 24 in a state where the operation of the fuel cell 18 is not started, supplies the hydrogen gas to the anode 57, generates an electromotive force based on an activity difference (concentration difference, partial pressure difference) of the hydrogen gas between the anode 57 and the cathode 56, configures the fuel cell 18 as a hydrogen concentration cell, and precharges the smoothing capacitor 130 with the electrical power Pfc supplied from the fuel cell 18 configured as the hydrogen concentration cell.

Thus, in the present embodiment, the smoothing capacitor 130 can be precharged without using the precharge circuit 134 (the precharge contactor 136 and the current limiting resistor 138). As a result, it is not necessary to provide the precharge circuit 134 for the main contactor 108. The precharge circuit 134 can be removed from the FCVCU 140, and the number of components of the fuel cell system 10 can be minimized and the cost can be reduced.

In relation to the above-described embodiment, the following supplementary notes are further disclosed.

### Supplementary Note 1

In the method of starting the operation of the fuel cell system (10) according to the present disclosure, the fuel cell system includes the fuel cell (18) configured to generate electrical power through the electrochemical reaction between the hydrogen gas supplied from the fuel gas supply device (24) to the anode (57) and the oxygen-containing gas supplied from the oxygen-containing gas supply device (22) to the cathode (56), and the boost converter (100) including the capacitor (130) in the output stage and configured to increase the output voltage (Vfc) of the fuel cell, and the method includes the step (S2) of, in the state where the operation of the fuel cell is not started, supplying the hydrogen gas to the anode, and generating the electromotive force based on the activity difference of the hydrogen gas between the anode and the cathode to configure the fuel cell as the hydrogen concentration cell, and the step (S3) of precharging the capacitor with the electrical power (Pfc) supplied from the fuel cell configured as the hydrogen concentration cell.

In accordance with such a method, the capacitor can be precharged without using a precharge circuit. Therefore, the number of components of the fuel cell system can be minimized, the cost can be reduced, and a more favorable method of starting operation of the fuel cell system can be provided.

### Supplementary Note 2

In the method of starting the operation of the fuel cell system according to Supplementary Note 1, the step of precharging of the capacitor may include the step (S31) of electrically connecting the fuel cell and the capacitor, applying the output voltage of the fuel cell configured as the hydrogen concentration cell to the capacitor, and charging the capacitor, and the step (S32) of, after the capacitor is charged with the output voltage of the fuel cell, driving the boost converter to increase the output voltage of the fuel cell, applying an increased voltage to the capacitor to charge the capacitor.

In accordance with such a method, the capacitor can be quickly precharged.

### Supplementary Note 3

In the method of starting the operation of the fuel cell system according to Supplementary Note 1 or 2, the fuel cell system may further include the electrical power storage device (44), the contactor (108) provided between the electrical power storage device and the capacitor, and the oxygen-containing gas supply device including the compressor (28) that is connected in parallel with the capacitor on the primary side of the contactor, and the method may further include the step (S34) of, in the case where the capacitor is charged to the predetermined voltage value (Vth2), determining that precharge of the capacitor is completed, and the step (S5) of in the case where it is determined that the precharge of the capacitor is completed, closing the contactor to supply electrical power from the electrical power storage device to the compressor, and thereby driving the compressor to supply the oxygen-containing gas from the oxygen-containing gas supply device to the cathode.

In accordance with such a method, the hydrogen gas generated at the cathode can be scavenged to the outside of the fuel cell stack.

### Supplementary Note 4

In the method of starting the operation of the fuel cell system according to Supplementary Note 1 or 2, the fuel cell system may further include the electrical power storage device (44), the contactor (108) provided between the electrical power storage device and the capacitor, and the auxiliary equipment (28, 38, 60, 62) connected in parallel with the capacitor on the primary side of the contactor, and the method may further include the step (S34) of, in the case where the capacitor is charged to the predetermined voltage value (Vth2), determining that precharge of the capacitor is completed, the step (S5) of, in a case where it is determined that the precharge of the capacitor is completed, closing the contactor to supply electrical power from the electrical power storage device to the auxiliary equipment, and the step (S6) of driving the auxiliary equipment by using the supplied electrical power, and supplying the hydrogen gas to the anode and supplying the oxygen-containing gas to the cathode to cause the fuel cell to generate electrical power through the electrochemical reaction between the hydrogen gas and the oxygen-containing gas.

In accordance with such a method, the capacitor can be precharged without using a precharge circuit, and the operation of the fuel cell can be started.

### Supplementary Note 5

The fuel cell system according to the present disclosure includes the fuel cell (18) configured to generate electrical power through the electrochemical reaction between the hydrogen gas supplied from the fuel gas supply device (24) to the anode (57) and the oxygen-containing gas supplied from the oxygen-containing gas supply device (22) to the cathode (56), the boost converter (100) including the capacitor (130) in the output stage and configured to increase the output voltage (Vfc) of the fuel cell, and the control device (16) configured to control the fuel gas supply device, the oxygen-containing gas supply device, the fuel cell, and the boost converter, wherein the control device is configured to, in a state where the operation of the fuel cell is not started, drive the fuel gas supply device to supply the hydrogen gas to the anode, generate the electromotive force based on the activity difference of the hydrogen gas between the anode and the cathode to configure the fuel cell as the hydrogen concentration cell, and precharge the capacitor with the electrical power (Pfc) supplied from the fuel cell configured as the hydrogen concentration cell.

In accordance with such a configuration, the capacitor can be precharged without using a precharge circuit. Therefore, the number of parts of the fuel cell system can be minimized, and the cost can be reduced, so that a more favorable fuel cell system can be provided.

Although the present disclosure has been described in detail, the present disclosure is not necessarily limited to the specific embodiments described above. These embodiments can be subjected to various additions, substitutions, modifications, partial deletions, and the like, within a range that does not depart from the essence and gist of the present disclosure, or alternatively, the purpose and gist of the present disclosure as derived from the contents described in the claims and their equivalents. Further, these embodiments can also be implemented in combination. For example, in the above-described embodiments, the order of the operations and the order of the processes are shown merely as examples, and the present invention is not necessarily limited to these examples. Further, the same also applies to cases in which numerical values or mathematical expressions are used in the description of the aforementioned embodiments.

1. A method of starting operation of the fuel cell system, the fuel cell system including:
a fuel cell configured to generate electrical power through an electrochemical reaction between a hydrogen gas supplied from a fuel gas supply device to an anode and an oxygen-containing gas supplied from an oxygen-containing gas supply device to a cathode; and
a boost converter including a capacitor in an output stage and configured to increase an output voltage of the fuel cell,
the method comprising:
in a state where the operation of the fuel cell is not started, supplying the hydrogen gas to the anode, and generating an electromotive force based on an activity difference of the hydrogen gas between the anode and the cathode to configure the fuel cell as a hydrogen concentration cell; and
precharging the capacitor with an electrical power supplied from the fuel cell configured as the hydrogen concentration cell.

2. The method of starting the operation of the fuel cell system according to claim 1,
during the precharging of the capacitor, electrically connecting the fuel cell and the capacitor, applying the output voltage of the fuel cell configured as the hydrogen concentration cell to the capacitor, and charging the capacitor, and
after the capacitor is charged with the output voltage of the fuel cell, driving the boost converter to increase the output voltage of the fuel cell, applying an increased voltage to the capacitor to charge the capacitor.

3. The method of starting the operation of the fuel cell system according to claim 1,
wherein the fuel cell system further includes:
an electrical power storage device;
a contactor provided between the electrical power storage device and the capacitor; and
the oxygen-containing gas supply device including a compressor that is connected in parallel with the capacitor on a primary side of the contactor, and wherein the method further comprises:
in a case where the capacitor is charged to a predetermined voltage value, determining that precharge of the capacitor is completed; and
in a case where it is determined that the precharge of the capacitor is completed, closing the contactor to supply electrical power from the electrical power storage device to the compressor, and thereby driving the compressor to supply the oxygen-containing gas from the oxygen-containing gas supply device to the cathode.

4. The method of starting the operation of the fuel cell system according to claim 2,
wherein the fuel cell system further includes:
an electrical power storage device;
a contactor provided between the electrical power storage device and the capacitor; and
the oxygen-containing gas supply device including a compressor that is connected in parallel with the capacitor on a primary side of the contactor, and
wherein the method further comprises:
in a case where the capacitor is charged to a predetermined voltage value, determining that precharge of the capacitor is completed; and
in a case where it is determined that the precharge of the capacitor is completed, closing the contactor to supply electrical power from the electrical power storage device to the compressor, and thereby driving the compressor to supply the oxygen-containing gas from the oxygen-containing gas supply device to the cathode.

5. The method of starting the operation of the fuel cell system according to claim 1,
wherein the fuel cell system further includes:
an electrical power storage device;
a contactor provided between the electrical power storage device and the capacitor; and
auxiliary equipment connected in parallel with the capacitor on a primary side of the contactor, and
wherein the method further comprises:
in a case where the capacitor is charged to a predetermined voltage value, determining that precharge of the capacitor is completed;
in a case where it is determined that the precharge of the capacitor is completed, closing the contactor to supply electrical power from the electrical power storage device to the auxiliary equipment;
driving the auxiliary equipment by using the supplied electrical power, and supplying the hydrogen gas to the anode and supplying the oxygen-containing gas to the cathode to cause the fuel cell to generate electrical power through the electrochemical reaction between the hydrogen gas and the oxygen-containing gas.

6. The method of starting the operation of the fuel cell system according to claim 2,
wherein the fuel cell system further includes:
an electrical power storage device;
a contactor provided between the electrical power storage device and the capacitor; and
auxiliary equipment connected in parallel with the capacitor on a primary side of the contactor, and wherein the method further comprises:
in a case where the capacitor is charged to a predetermined voltage value, determining that precharge of the capacitor is completed;
in a case where it is determined that the precharge of the capacitor is completed, closing the contactor to supply electrical power from the electrical power storage device to the auxiliary equipment;
driving the auxiliary equipment by using the supplied electrical power, and supplying the hydrogen gas to the anode and supplying the oxygen-containing gas to the cathode to cause the fuel cell to generate electrical power through the electrochemical reaction between the hydrogen gas and the oxygen-containing gas.

7. A fuel cell system comprising:
a fuel cell configured to generate electrical power through an electrochemical reaction between a hydrogen gas supplied from a fuel gas supply device to an anode and an oxygen-containing gas supplied from an oxygen-containing gas supply device to a cathode;
a boost converter including a capacitor in an output stage and configured to increase an output voltage of the fuel cell; and
a control device including one or more processors that execute computer-executable instructions stored in a memory, and configured to control the fuel gas supply device, the oxygen-containing gas supply device, the fuel cell, and the boost converter,
wherein the one or more processors execute the computer-executable instructions to cause the control device to:
in a state where operation of the fuel cell is not started, drive the fuel gas supply device to supply the hydrogen gas to the anode;
generate an electromotive force based on an activity difference of the hydrogen gas between the anode and the cathode to configure the fuel cell as a hydrogen concentration cell; and
precharge the capacitor with an electrical power supplied from the fuel cell configured as the hydrogen concentration cell.
